(19) United States
(12) Patent Application Publication
(10) Pub. No.: US 2015/0154927 A1
(43) Pub. Date: Jun. 4, 2015

(54) GATE DRIVER-ON-ARRAY DRIVING CIRCUIT AND DRIVING METHOD

(71) Applicant: SHENZHEN CHINA STAR OPTOELECTRONICS TECHNOLOGY CO., LTD., Shenzhen (CN)

(72) Inventor: Chun-Huai Li, Shenzhen (CN)

(73) Assignee: SHENZHEN CHINA STAR OPTOELECTRONICS TECHNOLOGY CO., LTD., Shenzhen (CN)

(21) Appl. No.: 13/985,579

(22) PCT Filed: Jun. 25, 2013
(86) PCT No.: PCT/CN2013/077853

§ 371 Date: Aug. 15, 2013

(30) Foreign Application Priority Data
May 6, 2013 (CN) 201310162954.8

(51) Int. Cl. G09G 3/36

(52) U.S. Cl. CPC G09G 3/3677; G09G 2320/0219; G09G 2310/0289; G09G 2300/0819; G09G 2300/0871

(57) ABSTRACT

The present invention provides a gate driver-on-array (GOA) driving circuit and a driving method, which are used for generating a gate pulse to drive a scan line. The GOA driving circuit includes a GOA control unit utilized to generate a first control signal and a second control signal; a selective switch circuit coupled between the GOA control unit and the scan line, utilized to output the gate pulse according to the first control signal and the second control signal, the gate pulse having a high level and a low level; and a field effect transistor coupled to the selective switch circuit, utilized to turn on during the high level so that the gate pulse slopingly lowers to a predetermined level and then lowers to the low level.

### FIELD OF THE INVENTION

The present invention relates to a liquid crystal display production technique, and especially to a gate driver-on-array (GOA) driving circuit and a driving method.

### BACKGROUND OF THE INVENTION

A gate driver-on-array (GOA) technique which gates are integrated on an array substrate has been gradually applied to a liquid crystal display (LCD) field. However, with the increase in the size of LCD screens, the number of pixels in the LCD panel also has a massive increase, and transmission distances of driving signals also has a large increase. However, square waves of the driving signals have a distortion with the longer transmission distances, resulting in varying degrees of feedthrough phenomenon due to a capacitive coupling effect on the LCD panel, further causing the problem of uneven display.

To solve the uneven problem mentioned above, referring to FIG. 1, FIG. 1 is a schematic drawing illustrating a trimming circuit applied to the GOA technique in prior art. The trimming circuit 20 includes a power chip (power IC) 210, a timing controller chip (Tcon IC) 220, and a level shift circuit 230. The level shift circuit 230 adjusts the level of a power supply voltage Vdd provided by the power chip 210, and synchronizes it with a clock signal CLK-in inputted by the Tcon chip 220, thereby outputting a gate driving signal CLK-out with trimming. Referring to FIG. 2, FIG. 2 is a schematic drawing illustrating waveforms of a power supply voltage Vdd, a clock signal CLK-in, and a gate driving signal CLK-in in prior art. The power chip 210 herein has a special design, so that the outputted power supply voltage Vdd thereof has a level drop before the transition from a high level to a low level (falling edge), so as to cause the gate driving signal generated by the level shift circuit 230 to be the square waves CLK-out with the trimming.

However, it requires a complex circuit design to achieve the above power chip 210, and the cost of manufacture processes will relatively increase.

### SUMMARY OF THE INVENTION

An objective of the present invention is to provide a GOA driving circuit and a driving method to overcome the cost problem caused from the special design of the power chip in the prior art.

To solve the above-mentioned problem, a preferred embodiment of the present invention provides a GOA driving circuit, which is utilized to generate a gate pulse to drive a scan line. The GOA driving circuit includes a GOA control unit utilized to generate a first control signal and a second control signal, wherein the first control signal and the second control signal are in antiphase; a selective switch circuit coupled between the GOA control unit and the scan line, utilized to output the gate pulse according to the first control signal and the second control signal, the gate pulse having a high level and a low level; and a field effect transistor coupled to the selective switch circuit, utilized to turn on during the high level so that the gate pulse slopingly lowers to a predetermined level and then lowers to the low level, wherein the predetermined level is between the high level and the low level.

In the GOA driving circuit of the preferred embodiment of the present invention, the on and off states of the field effect transistor are controlled by a first clock signal. More specifically, a duration that the gate pulse slopingly lowers to the predetermined level corresponds to a square wave of the first clock signal.

In the GOA driving circuit of the preferred embodiment of the present invention, the field effect transistor receives a control voltage for controlling a voltage value of the predetermined level. Moreover, the voltage value of the predetermined level is equal to the control voltage minus a threshold voltage.

In the GOA driving circuit of the preferred embodiment of the present invention, the field effect has a gate, a source and a drain, the gate receives the first clock signal, the source receives the control voltage, and the drain is electrically coupled to the selective switch circuit. The selective switch circuit includes: a first thin film transistor which has a first gate, a first source and a first drain, the first gate receiving the first control signal and electrically coupled to the drain of the field effect transistor, the first source receiving a predetermined clock signal; and a second thin film transistor which has a second gate, a second source and a second drain, the second gate receiving the second control signal, the second source electrically coupled to the first drain and the scan line, the second drain receiving a low level signal.

In the GOA driving circuit of the preferred embodiment of the present invention, the first gate receives a level signal which slopingly lowers to the control voltage from a second high level, so as to shape the gate pulse to slopingly lower.

Similarly, to solve the above-mentioned problem, another preferred embodiment of the present invention provides a driving method of a GOA driving circuit, which is used for generating a gate pulse to drive a scan line. The gate pulse has a high level and a low level. The GOA driving circuit includes a GOA control unit, a selective switch circuit coupled between the GOA control unit and the scan line, and a field effect transistor coupled to the selective switch circuit. The driving method includes: controlling the field effect transistor to turn on during the high level so that the gate pulse slopingly lowers to a predetermined level and then lowers to the low level, wherein the predetermined level is between the high level and the low level.

In the driving method of the GOA driving circuit of the preferred embodiment of the present invention, the driving method further includes: providing a control voltage to the field effect transistor for controlling a voltage value of the predetermined level, wherein the voltage value of the predetermined level is equal to the control voltage minus a threshold voltage.

In comparison with the prior art, the present invention does not change the design of the power chip, but disposes the field effect transistor on the GOA panel, and controls the on state of the field effect transistor according to the first clock signal for determining a trimming width of the gate pulse. In addition, the control voltage can be provided for determining the voltage value of the predetermined level; that is, a trimming depth can be controlled. Therefore, the invention dose not need to adopt the complex power chip, and the production cost is reduced.

It is to be understood that both the foregoing general description and the following detailed description of the present invention are exemplary and explanatory and are intended to provide further explanation of the invention as claimed.

### DESCRIPTION OF THE DRAWINGS

FIG. 1 is a schematic drawing illustrating a trimming circuit applied to a GOA technique in prior art;

FIG. 2 is a schematic drawing illustrating waveforms of a power supply voltage, a clock signal, and a gate driving signal in prior art;

FIG. 3 is a block diagram illustrating a GOA driving circuit according to a preferred embodiment of the present invention;

FIG. 4 is a schematic drawing illustrating waveforms of related signals of the GOA driving circuit according to the preferred embodiment of the present invention;

FIG. 5 is a schematic drawing illustrating a specific circuit of FIG. 3; and

FIG. 6 is a flow chart illustrating a driving method for the GOA driving circuit according to one preferred embodiment of the present invention.

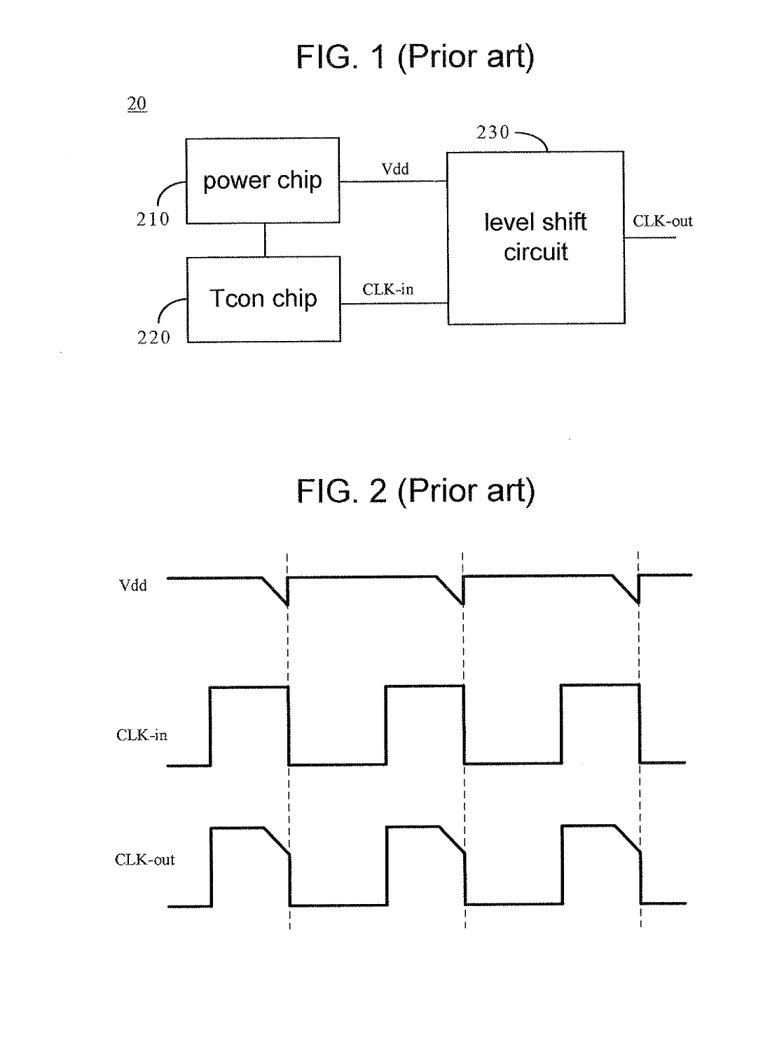

### DETAILED DESCRIPTION OF THE PREFERRED EMBODIMENTS

Descriptions of the following embodiments refer to attached drawings which are utilized to exemplify specific embodiments.

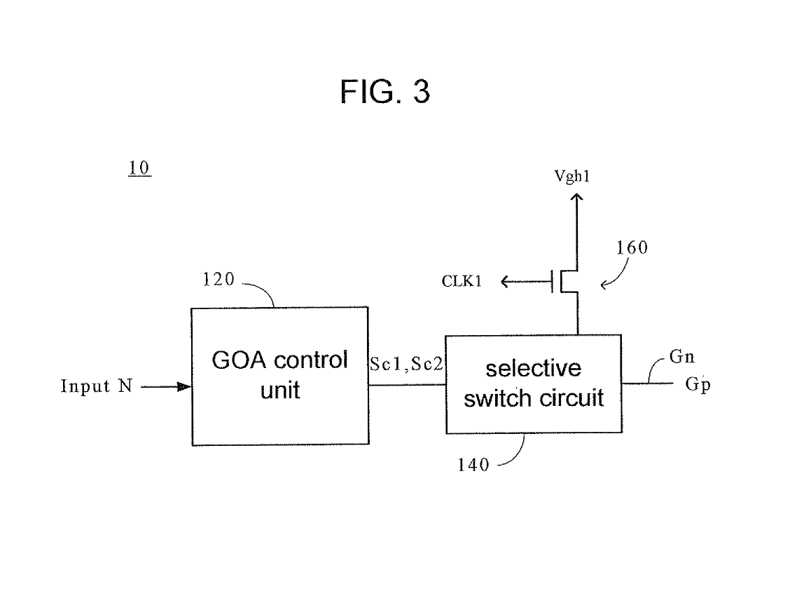

Referring to FIG. 3, FIG. 3 is a block diagram illustrating a GOA driving circuit according to a preferred embodiment of the present invention. The GOA driving circuit 10 of the embodiment is integrated on an array substrate. The GOA driving circuit 10 corresponds to one row of pixels, and the GOA driving circuit 10 is utilized to drive one scan line Gn. Therefore, on the array substrate, the number of the GOA driving circuit 10 is equal to the number of the scan lines. In order to explain clearly, the drawing only shows a single GOA driving circuit 10.

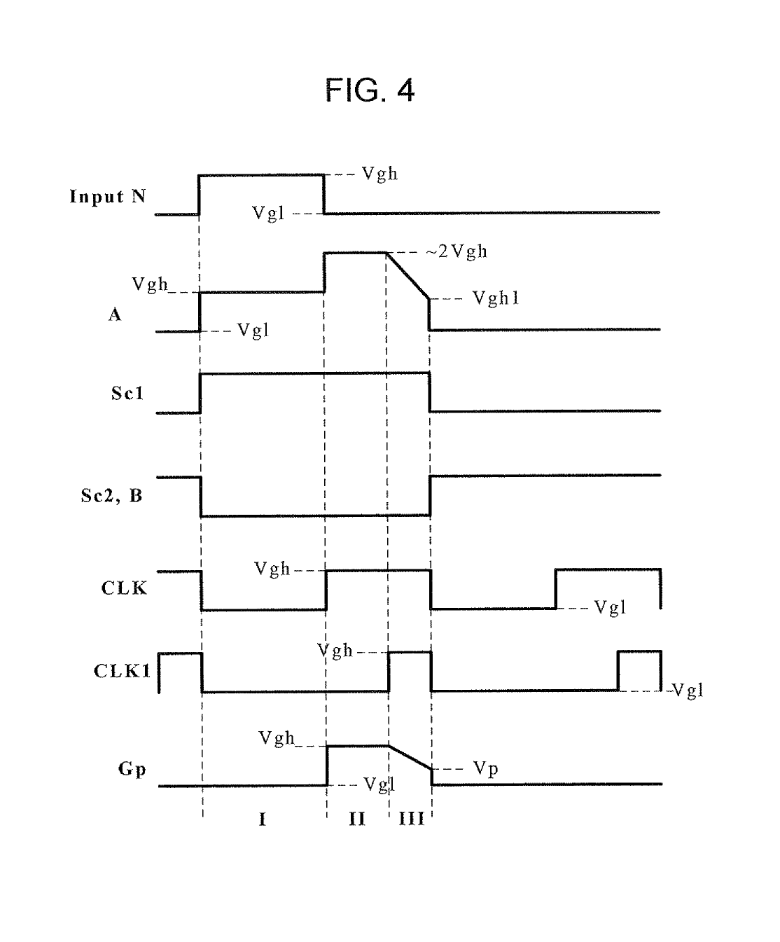

Referring to FIG. 3 and FIG. 4, FIG. 4 is a schematic drawing illustrating waveforms of related signals of the GOA driving circuit according to the preferred embodiment of the present invention. The GOA driving circuit is used for generating a gate pulse Gp to drive the scan line Gp (will explain that later on). The GOA driving circuit includes a GOA control unit 120, a selective switch circuit 140, and a field effect transistor 160. The GOA control unit 120 receives a preceding input N. The preceding input N is generated from a GOA driving circuit that corresponds to a previous scan line Gn−1 (not shown). The GOA control unit 120 is utilized to generate a first control signal Sc1 and a second control signal Sc2 (as shown in FIG. 4), and the first control signal Sc1 and the second control signal Sc2 herein are in antiphase.

As shown in FIG. 3, the selective switch circuit 140 is coupled between the GOA control unit 120 and the scan line Gn, and utilized to output the gate pulse Gp according to the first control signal Sc1 and the second control signal Sc2. As shown in the drawing, the gate pulse Gp has a high level Vgh and a low level Vgl, in which the high level Vgh is a voltage value being enough to make thin film transistors on the row of pixels turn on, and the low level Vgl is a voltage value to make the thin film transistors turn off.

Referring to FIG. 3 and FIG. 4, the field effect transistor 160 is coupled to the selective switch circuit 140, and is utilized to turn on during the high level, so that the gate pulse Gp slopingly lowers to a predetermined level Vp and then lowers to the low level Vgl, thereby realizing the purpose of trimming. The predetermined level Vp herein is between the high level Vgh and the low level Vgl. It is worth mentioning that the gate pulse Gp may lower in a constant slope or lower in a parabolic manner to the predetermined level Vp, and then vertically drop to the low level Vgl.

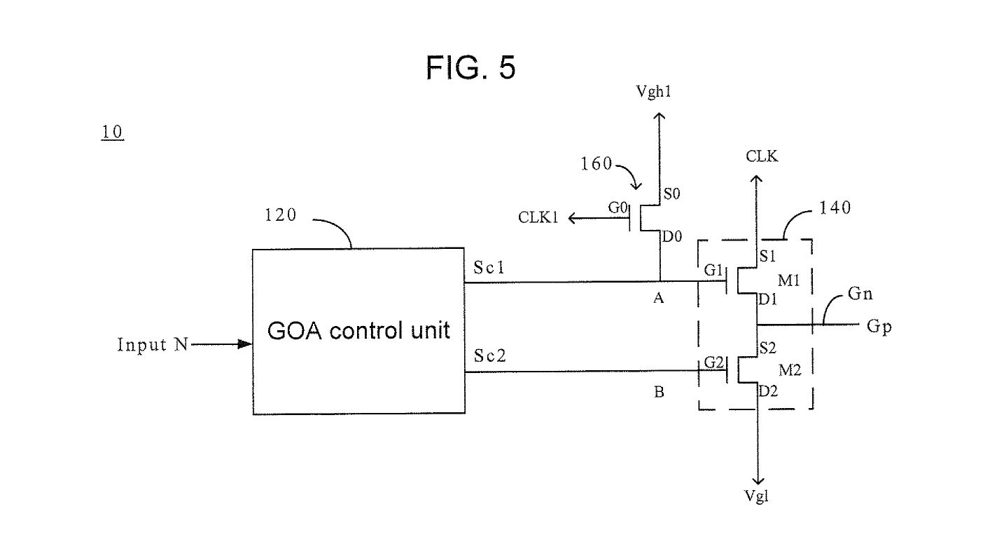

What follows is a detail of the working principle with respect to the GOA driving circuit 10. Referring to FIG. 4 and FIG. 5, FIG. 5 is a schematic drawing illustrating a specific circuit of FIG. 3. The on and off states of the field effect transistor 160 are controlled by a first clock signal CLK1. More specifically, as shown in FIG. 4, a duration that the gate pulse Gp slopingly lowers to the predetermined level Vp corresponds to a square wave of the first clock signal CLK1. As shown in FIG. 5, the field effect transistor 160 receives a control voltage Vgh1 for controlling the voltage value of the predetermined level Vp. Specifically, the field effect transistor 160 has a gate G0, a source S0, and a drain D0. The gate G0 receives the first clock signal CLK1, the source S0 receives the control voltage Vgh1, and the drain D0 is electrically coupled to the selective switch circuit 140.

Referring to FIG. 5, the selective switch circuit 140 includes a first thin film transistor M1 and a second thin film transistor M2. The first thin film transistor M1 has a first gate G1, a first source S1 and a first drain D1. The first gate G1 receives the first control signal Sc1 and is electrically coupled to the drain D0 of the field effect transistor 160. The first source S1 receives a predetermined clock signal CLK. The second thin film transistor M2 has a second gate G2, a second source S2 and a second drain D2. The second gate G2 receives the second control signal Sc2, the second source S2 is electrically coupled to the first drain D1, and the scan line Gn, the second drain D2 receives a low level Vgl signal.

As shown in FIG. 4, specifically, at the time interval I, the signal (i.e. the voltage of point A) that controls the first thin film transistor M1 to turn on and off is set at the high level Vgh. The first source S1 is at the low level Vgl. The first thin film transistor M1 is turned on, and the first drain D1 is at the low level Vgl of the predetermined clock signal CLK. On the other hand, the signal (i.e. the voltage of point B) that controls the second thin film transistor M2 to turn on and off is set at the low level Vgl. The second thin film transistor M2 is cut off. The second source S2 is at the low level Vgl, and the gate pulse Gp is at the low level Vgl.

At the time interval II, the first gate G1 of the first thin film transistor M1 is instantly transited to a float state. Since the capacitance effect of the first thin film transistor M1, a voltage difference between the first gate G1 and the first source S1 must be the same. Because CLK transits to the high level Vgh, the voltage of the point A is pulled to about twice as high as the high level Vgh. Meanwhile, the first thin film transistor M1 is still turned on, and the second thin film transistor M2 is still cut off; thus, the output of the gate pulse Gp is the high level Vgh.

At the time interval III, because the first clock signal CLK1 is set at the high level Vgh, the field effect transistor 160 is turned on, the source S0 is interconnect with the drain D0, and thus the voltage of the point A gradually lowers to the control voltage Vgh1 from 2Vgh. On the other hand, as to the first thin film transistor M1, the voltage difference between the first gate G1 and the first source S1 is gradually approaching a threshold voltage Vth. The first thin film transistor M1 is operating in a linear or triode region, so the relationship Vds and Ids is as a linear resistor. Therefore, at the end of the time interval III, the voltage value of the predetermined level Vp outputted from the gate pulse Gp is equal to the control voltage Vgh1 minus the threshold voltage Vth, i.e. Vp=Vgh1−Vp. That is to say, the first gate G1 receives a level signal which slopingly lowers to the control voltage Vgh1 from a second high level (i.e. twice as much as high level ˜2Vgh), so as to shape the gate pulse Gp to slopingly lower, thereby realizing the purpose of trimming.

It is worth mentioning that the field effect transistor 160 can be a N-channel MOSFET. Preferably, the field effect transistor 160, first thin film transistor M1 and second thin film transistor M2 are the same thin film transistors, so they have an identical threshold voltage Vth.

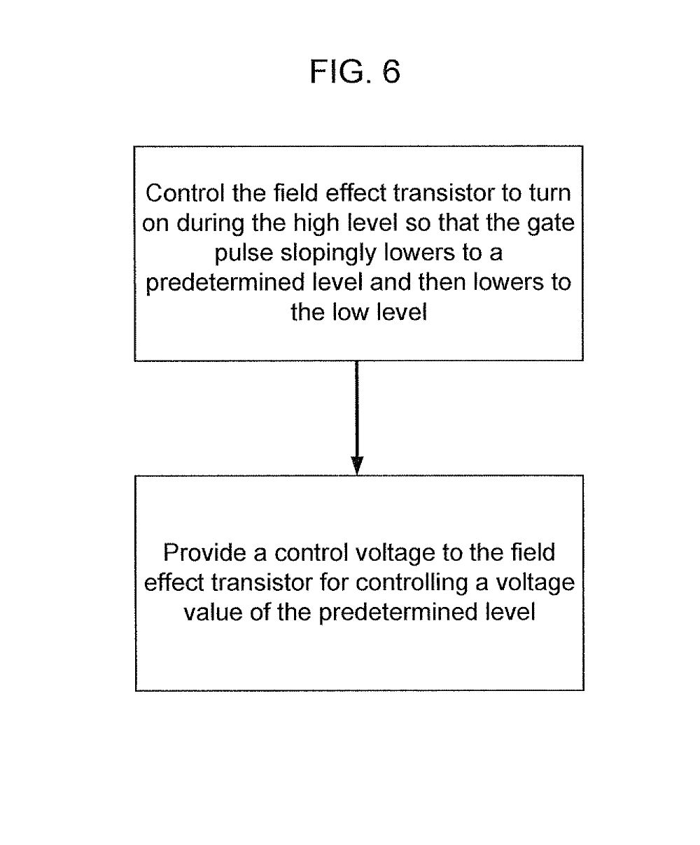

The driving method employing the GOA driving circuit 10 of the above-mentioned embodiment will be explained in the following. Referring to FIG. 6, FIG. 6 is a flow chart illustrating a driving method for the GOA driving circuit according to one preferred embodiment of the present invention. The driving method of the embodiment is utilized to generate the gate pulse Gp to drive the scan line Gn. The gate pulse Gp has a high level Vgh and a low level Vgl. The GOA driving circuit 10 includes the GOA control unit 120, the selective switch circuit 140 coupled between the GOA control unit 120 and the scan line Gn, and the field effect transistor 160 coupled to the selective switch circuit 160. The descriptions of these elements have been explained as mentioned previously, so no further detail will be provided herein.

As shown in FIG. 6, the driving method includes steps S10 and S20. At step S10, the field effect transistor 160 is controlled to turn on during the high level Vgh so that the gate pulse Gp slopingly lowers to the predetermined level Vp and then lowers to the low level Vgl, in which the predetermined level Vp is between the high level Vgh and the low level Vgl.

At step S20, a control voltage Vgh1 is provided to the field effect transistor 160 for controlling the voltage value of the predetermined level Vp, in which the voltage value of the predetermined level Vp is equal to the control voltage Vgh1 minus a threshold voltage Vth. The purpose of trimming can be realized by the above-mentioned steps.

In summary, the present invention does not change the design of the power chip, but disposes the field effect transistor 160 on the GOA panel, and controls the on state of the field effect transistor 160 according to the first clock signal CLK1 for determining the trimming width of the gate pulse Gp. In addition, the control voltage Vgh1 can be provided for determining the voltage value of the predetermined level Vp; that is, the trimming depth can be controlled. Therefore, the invention does not need to adopt the complex power chip, and the production cost is reduced.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A gate driver-on-array (GOA) driving circuit for generating a gate pulse to drive a scan line, comprising:
a GOA control unit utilized to generate a first control signal and a second control signal, wherein the first control signal and the second control signal are in antiphase;
a selective switch circuit coupled between the GOA control unit and the scan line, utilized to output the gate pulse according to the first control signal and the second control signal, the gate pulse having a high level and a low level; and
a N-channel MOSFET coupled to the selective switch circuit, utilized to turn on during the high level so that the gate pulse slopingly lowers to a predetermined level and then lowers to the low level, wherein the predetermined level is between the high level and the low level.

2. The GOA driving circuit according to claim 1, wherein the on and off states of the N-channel MOSFET are controlled by a first clock signal.

3. The GOA driving circuit according to claim 2, wherein the N-channel MOSFET receives a control voltage for controlling a voltage value of the predetermined level, and wherein the voltage value of the predetermined level is equal to the control voltage minus a threshold voltage.

4. The GOA driving circuit according to claim 3, wherein the N-channel MOSFET has a gate, a source and a drain, the gate receives the first clock signal, the source receives the control voltage, and the drain is electrically coupled to the selective switch circuit.

5. The GOA driving circuit according to claim 4, wherein the selective switch circuit comprises:
a first thin film transistor having a first gate, a first source and a first drain, the first gate receiving the first control signal and electrically coupled to the drain of the N-channel MOSFET, the first source receiving a predetermined clock signal; and
a second thin film transistor having a second gate, a second source and a second drain, the second gate receiving the second control signal, the second source electrically coupled to the first drain and the scan line, the second drain receiving a low level signal;
and wherein the N-channel MOSFET, the first thin film transistor and the second thin film transistor are identical thin film transistors.

6. A gate driver-on-array (GOA) driving circuit for generating a gate pulse to drive a scan line, comprising:
a GOA control unit utilized to generate a first control signal and a second control signal, wherein the first control signal and the second control signal are in antiphase;
a selective switch circuit coupled between the GOA control unit and the scan line, utilized to output the gate pulse according to the first control signal and the second control signal, the gate pulse having a high level and a low level; and
a field effect transistor coupled to the selective switch circuit, utilized to turn on during the high level so that the gate pulse slopingly lowers to a predetermined level and then lowers to the low level, wherein the predetermined level is between the high level and the low level.

7. The GOA driving circuit according to claim 6, wherein the on and off states of the field effect transistor are controlled by a first clock signal.

8. The GOA driving circuit according to claim 7, wherein a duration that the gate pulse slopingly lowers to the predetermined level corresponds to a square wave of the first clock signal.

9. The GOA driving circuit according to claim 7, wherein the field effect transistor receives a control voltage for controlling a voltage value of the predetermined level.

10. The GOA driving circuit according to claim 9, wherein the voltage value of the predetermined level is equal to the control voltage minus a threshold voltage.

11. The GOA driving circuit according to claim 9, wherein the field effect has a gate, a source and a drain, the gate receives the first clock signal, the source receives the control voltage, and the drain is electrically coupled to the selective switch circuit.

12. The GOA driving circuit according to claim 11, wherein the selective switch circuit comprises:
a first thin film transistor having a first gate, a first source and a first drain, the first gate receiving the first control signal and electrically coupled to the drain of the field effect transistor, the first source receiving a predetermined clock signal; and
a second thin film transistor having a second gate, a second source and a second drain, the second gate receiving the second control signal, the second source electrically coupled to the first drain and the scan line, the second drain receiving a low level signal.

13. The GOA driving circuit according to claim 12, wherein the first gate receives a level signal which slopingly lowers to the control voltage from a second high level, so as to shape the gate pulse to slopingly lower.

14. A driving method of a GOA driving circuit for generating a gate pulse to drive a scan line, the gate pulse having a high level and a low level, the GOA driving circuit comprising a GOA control unit, a selective switch circuit coupled between the GOA control unit and the scan line, and a field effect transistor coupled to the selective switch circuit, the driving method comprising:
controlling the field effect transistor to turn on during the high level so that the gate pulse slopingly lowers to a predetermined level and then lowers to the low level, wherein the predetermined level is between the high level and the low level.

15. The driving method according to claim 14, wherein the driving method further comprising:
providing a control voltage to the field effect transistor for controlling a voltage value of the predetermined level, wherein the voltage value of the predetermined level is equal to the control voltage minus a threshold voltage.
